(19) United States
(12) Patent Application Publication
(10) Pub. No.: US 2025/0190224 A1
(43) Pub. Date: Jun. 12, 2025

(54) METHODS, APPARATUSES, DEVICES, AND MEDIA FOR PROCESSING A MINI-PROGRAM

(71) Applicant: Beijing Zitiao Network Technology Co., Ltd., Beijing (CN)

(72) Inventor: Shuai Shao, Beijing (CN)

(21) Appl. No.: 18/962,511

(22) Filed: Nov. 27, 2024

(30) Foreign Application Priority Data
Dec. 6, 2023 (CN) 202311667993.3

(51) Int. Cl. G06F 9/445

(52) U.S. Cl. CPC G06F 9/445

(57) ABSTRACT

Methods, apparatuses, devices, and media for processing a mini-program are provided. In a method, a scene configuration associated with a mini-program is obtained, the mini-program is configured to manage a plurality of data tables, the scene configuration specifies a plurality of application scenes provided in the mini-program, an application scene in the plurality of application scenes corresponds to a data table in the plurality of data tables, and the data table is an online spreadsheet. The plurality of data tables is loaded based on the scene configuration. A plurality of switching controls corresponding to the plurality of data tables are respectively presented in the mini-program. It is not necessary to write code and implement the mini-program by a professional developer, but an entry of a data table accessed by each application scene provided by the mini-program can be specified through the scene configuration.

### CROSS-REFERENCE

The present application claims priority to Chinese Patent Application No. 202311667993.3, filed on Dec. 6, 2023 and entitled “METHODS, APPARATUSES, DEVICES, AND MEDIA FOR PROCESSING A MINI-PROGRAM”, the entirety of which is incorporated herein by reference.

### FIELD

Example implementations of the present disclosure generally relate to the field of computers, and in particular to methods, apparatuses, devices, and computer-readable storage media for processing a mini-program based on a scene configuration.

### BACKGROUND

With the development of mobile Internet, developers can develop a mini-program which is hosted in a native application and runs on a mobile terminal. The native application refers to an application program that can run directly on a current operating system. The mini-program is an application program that can be used without downloading and installation. Currently, data from different data sources can be accessed and managed by using a mini-program. However, for a specific data source, it is necessary for a professional to develop a dedicated mini-program for accessing and managing the data source. At this time, it is expected to access the data source in a more flexible and convenient manner. For example, it is expected that an ordinary user may quickly develop a mini-program for accessing and managing the data source without programming knowledge.

### SUMMARY

In a first aspect of the present disclosure, a method for processing a mini-program is provided. The method comprises: obtaining a scene configuration associated with the mini-program, the mini-program being configured to manage a plurality of data tables, the scene configuration specifying a plurality of application scenes provided in the mini-program, an application scene in the plurality of application scenes corresponding to a data table in the plurality of data tables, and the data table being an online spreadsheet; loading the plurality of data tables based on the scene configuration; and presenting a plurality of switching controls corresponding to the plurality of data tables in the mini-program, respectively.

In a second aspect of the present disclosure, an apparatus for processing a mini-program is provided. The apparatus comprises: an obtaining module, configured to obtain a scene configuration associated with the mini-program, the mini-program being configured to manage a plurality of data tables, the scene configuration specifying a plurality of application scenes provided in the mini-program, an application scene in the plurality of application scenes corresponding to a data table in the plurality of data tables, and the data table being an online spreadsheet; a loading module, configured to load the plurality of data tables based on the scene configuration; and a presenting module, configured to present a plurality of switching controls corresponding to the plurality of data tables in the mini-program, respectively.

In a third aspect of the present disclosure, an electronic device is provided. The electronic device comprises: at least one processing unit; and at least one memory coupled to the at least one processing unit and storing instructions executable by the at least one processing unit, the instructions, when executed by the at least one processing unit, causing the electronic device to perform the method according to the first aspect of the present disclosure.

In a fourth aspect of the present disclosure, a computer-readable storage medium having a computer program stored thereon, the computer program, when executed by a processor, causing the processor to implement the method according to the first aspect of the present disclosure.

It should be appreciated that the content described in this Summary section is not intended to limit key or important features of the implementations of the present disclosure, nor is it intended to limit the scope of the present disclosure. Other features of the present disclosure will become easily comprehensible through the following description.

### BRIEF DESCRIPTION OF THE DRAWINGS

Hereinafter, the above and other features, advantages and aspects of the implementations of the present disclosure will become more apparent in conjunction with the accompanying drawings and with reference to the following detailed description. In the drawings, the same or similar reference signs denote the same or similar elements, wherein:

FIG. 1 illustrates a block diagram of an application environment according to some example implementations of the present disclosure;

FIG. 2 illustrates a block diagram of managing a mini-program based on a scene configuration according to some implementations of the present disclosure;

FIG. 3 illustrates a block diagram of a multi-layer architecture of a mini-program according to some implementations of the present disclosure;

FIG. 4 illustrates a block diagram of a structure of a scene configuration according to some implementations of the present disclosure;

FIG. 5 illustrates a block diagram of a home page of a mini-program according to some implementations of the present disclosure;

FIG. 6 illustrates a block diagram of an initial page of a mini-program according to some implementations of the present disclosure;

FIG. 7 illustrates a block diagram of a list page of a mini-program according to some implementations of the present disclosure;

FIG. 8 illustrates a block diagram of a detailed page of a mini-program according to some implementations of the present disclosure;

FIG. 9 illustrates a block diagram of a forwarding page of a mini-program according to some implementations of the present disclosure;

FIG. 10 illustrates a flowchart of a method for managing a mini-program based on a scene configuration according to some implementations of the present disclosure;

FIG. 11 illustrates a block diagram of an apparatus for managing a mini-program based on a scene configuration according to some implementations of the present disclosure; and

FIG. 12 illustrates a block diagram of a device capable of implementing a plurality of implementations of the present disclosure.

### DETAILED DESCRIPTION

Implementations of the present disclosure will be described in more detail below with reference to the accompanying drawings. Although some implementations of the present disclosure are shown in the drawings, it should be understood that the present disclosure may be implemented in various forms and should not be construed as being limited to the implementations set forth herein. Rather, these implementations are provided for a more thorough and complete understanding of the present disclosure. It should be understood that the drawings and implementations of the present disclosure are only for example purposes, and are not intended to limit the scope of protection of the present disclosure.

In the description of the implementations of the present disclosure, the term “include/comprise” and similar terms should be understood as open inclusion, that is, “include/comprise but not limited to”. The term “based on” should be understood as “at least partially based on”. The term “an implementation” or “the implementation” should be understood as “at least one implementation”. The term “some implementations” should be understood as “at least some implementations”. Other explicit and implicit definitions may also be included below. As used herein, the term “model” may represent an association relationship between various data. For example, the above association relationship may be obtained based on a variety of technical solutions known at present and/or to be developed in the future.

It should be understood that the data involved in the technical solutions of the present disclosure (including but not limited to the data itself, the acquisition or use of the data) should comply with the requirements of the corresponding laws, regulations and relevant provisions.

It should be understood that before using the technical solutions disclosed in the embodiments of the present disclosure, the type, scope of use, usage scenarios, and the like of personal information involved in the present disclosure should be informed to the users and the users' authorization should be obtained in an appropriate manner in accordance with relevant laws and regulations.

For example, when a user's active request is received, a prompt message is sent to the user to explicitly prompt the user that an operation requested by the user will require the acquisition and use of the user's personal information. Thereby, the user can independently choose whether to provide personal information to the software or hardware (such as an electronic device, an application program, a server, or a storage medium) that executes the operation of the technical solution of the present disclosure according to the prompt message.

As an optional but non-restrictive implementation, the manner of sending the prompt message to the user in response to receiving the active request from the user may be, for example, a pop-up window, and the prompt message may be presented in text in the pop-up window. In addition, the pop-up window may also carry a selection control for the user to select “agree” or “disagree” to provide personal information to the electronic device.

It should be understood that the above notification and user authorization acquisition process are merely illustrative and do not limit the implementations of the present disclosure. Other manners that meet relevant laws and regulations may also be applied to the implementations of the present disclosure.

The term “in response to” as used herein indicates a state in which a corresponding event occurs or a condition is satisfied. It will be understood that the execution timing of a subsequent action performed in response to the event or the condition is not necessarily strongly correlated with the time when the event occurs or the condition is satisfied. For example, in some cases, the subsequent action may be immediately executed upon the occurrence of the event or the establishment of the condition; while in some other cases, the subsequent action may be executed after the occurrence of the event or the establishment of the condition for some time.

### Example Environment

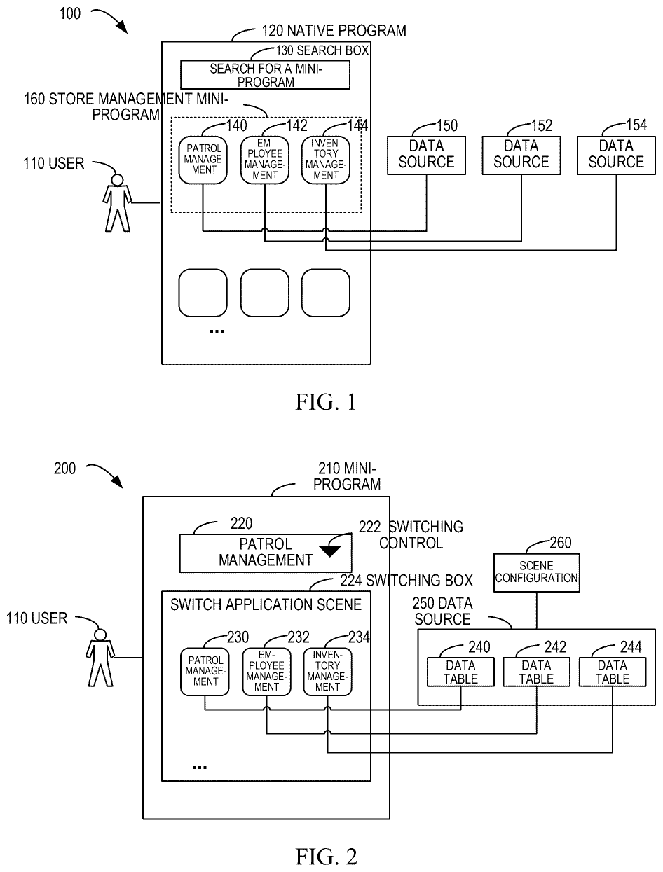

As briefly mentioned above, a mini-program is a functional software or application running on a native application. With reference to FIG. 1, an application environment according to an example implementation of the present disclosure is described. FIG. 1 illustrates a block diagram 100 of an application environment according to an example implementation of the present disclosure. As shown in FIG. 1, a native program 120 may host one or more mini-programs, and a mini-program for performing various functions may be developed based on the mini-program technology. For example, a plurality of store management mini-programs 160 may be developed. A mini-program 140 may provide a patrol management function and store corresponding data in a data store 150 (for example, a database). A mini-program 142 may provide an employee management function and store corresponding data in a data store 152. A mini-program 144 may provide an inventory management function and store corresponding data in a data store 154. A user 110 may enter the name of a desired mini-program in a search box 130 and find the desired mini-program.

However, for a specific data source, it is necessary to develop a dedicated mini-program by a professional for accessing and managing the data source. Further, after the mini-program development is completed, if the user finds a problem to be solved during the use process, the user cannot solve the problem by himself/herself but needs a professional to modify the code of the mini-program. In this case, it is expected to access and manage the data source in a more flexible and convenient manner. For example, it is expected that an ordinary user can quickly develop a mini-program for accessing and managing the data source without programming knowledge.

### Overview of Managing a Mini-Program

In order to at least partially solve the deficiencies in the prior art, according to an example implementation of the present disclosure, a method for processing a mini-program is proposed. In summary, with the example implementation of the present disclosure, the mini-program may provide different application scenes, and may access different data tables in the data source in different application scenes. Further, a scene configuration may be used to describe an association relationship between the application scenes and the data tables. In this way, the mini-program may be directly generated based on the scene configuration, and the function of the mini-program is adjusted by only modifying the scene configuration. In this way, the development process of the mini-program can be greatly simplified, thereby supporting ordinary users who do not have programming knowledge to quickly develop and/or adjust the mini-program for accessing and managing the data source.

Referring to FIG. 2, an overview according to an example implementation of the present disclosure is described. FIG. 2 illustrates a block diagram 200 of managing a mini-program based on a scene configuration according to some implementations of the present disclosure. As shown in FIG. 2, a mini-program 210 may access and manage a data source 150 including a plurality of data tables 240, 242, . . . , 244. Further, the mini-program 210 may support a plurality of application scenes, and each application scene may complete one or more functions. For example, an application scene 230 may perform a patrol management function, an application scene 232 may implement an employee management function, an application scene 234 may implement an inventory management function, and so on.

As shown in FIG. 2, a block 220 shows an application scene currently selected, and a user 110 may open a switching box 224 by clicking a switching control 222 to select a desired application scene from the plurality of application scenes. It should be understood that each application scene may correspond to a respective data table. For example, the application scene 230 may correspond to a data table 240 (for storing patrol-related data), the application scene 232 may correspond to a data table 242 (for storing employee-related data), and the application scene 234 may correspond to a data table 244 (for storing inventory-related data).

When the mini-program 210 is started, a scene configuration 260 associated with the mini-program 210 may be obtained. The scene configuration 260 may specify the plurality of application scenes 230, 232, 234, etc., provided in the mini-program 210, where the plurality of application scenes respectively correspond to the plurality of data tables. It should be understood that the data table herein may be an online spreadsheet, for example, a spreadsheet provided by an online data storage device and accessible to users online. Further, the plurality of data tables 240, 242, 255, etc., may be loaded from a data source 250 based on the scene configuration 260. Subsequently, a plurality of switching controls corresponding to the plurality of data tables may be presented in the mini-program 210 respectively.

With the example implementation of the present disclosure, an association relationship may be established between each application scene supported by the mini-program 210 and a corresponding data table in the data source 250 through the scene configuration 260. In this way, it is not necessary to write code to implement the mini-program by a professional developer, but an entry of a data table accessed by each application scene provided by the mini-program 210 may be specified through the scene configuration 260, and a function of accessing a desired data table may be implemented by the switching control.

### Detailed Process of Managing a Mini-Program

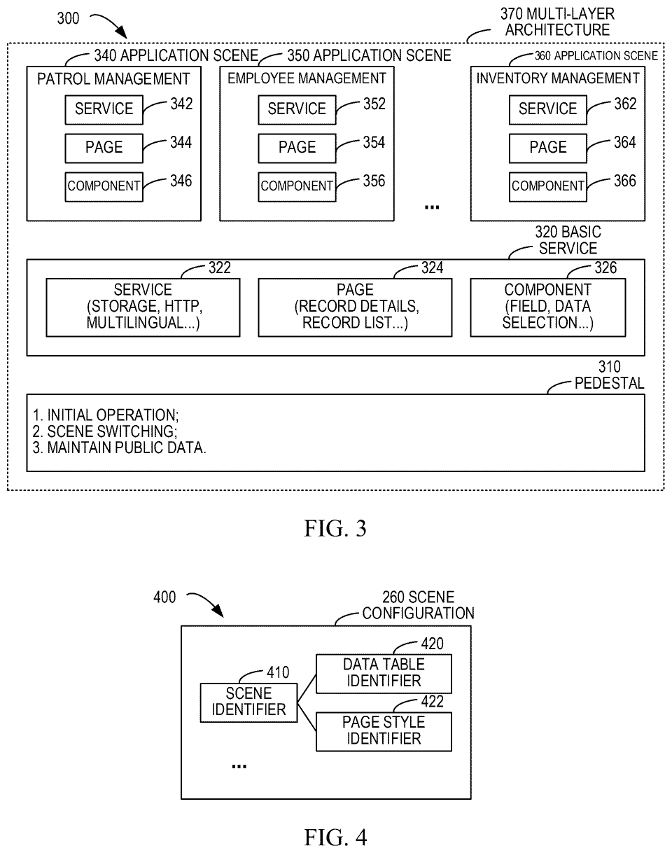

The overview of managing the mini-program based on the scene configuration has been described. Hereinafter, referring to FIG. 3, an architecture of the mini-program for supporting the above management function is described. FIG. 3 illustrates a block diagram 300 of a multi-layer architecture 370 of a mini-program according to some implementations of the present disclosure. As shown in FIG. 3, a pedestal 310 may be provided at the bottom layer of the multi-layer architecture. The pedestal 310 may be used as an entry of the mini-program to perform an initial operation to provide some common functions. For example, user login and tenant configuration parsing may be provided. Further, a home page container may be provided, and the home page may include a unified navigation bar, so that the user can seamlessly switch between different application scenes. Further, a responsive shared data center may be provided for storing public data shared in a plurality of application scenes.

At the basic service 320 layer, the basic service 322 that may be used in each application scene may be provided, such as basic storage services, HyperText Transfer Protocol (HTTP) services, multilingual services, and so on. Further, the basic service 320 may provide a source for presentation, and so on. The basic service 320 may provide a component 326 function for performing functions such as fields selection, and data selection.

Further, a plurality of application scenes 340, 350, . . . , 360 may be provided above the basic service 320 layer. At this time, each application scene may call the service 322, the page 324, and the component 326 provided at the basic service 320 layer to complete respective functions. For example, the application scene 340 may call the service 342, the page 344, and the component 346 to provide a patrol management function. The application scene 350 may call the service 352, the page 354, and the component 356 to provide an employee management function. The application scene 360 may call the service 362, the page 364, and the component 366 to provide an inventory management function, and so on.

According to an example implementation of the present disclosure, if an operation instruction from a user for starting the mini-program is received, an initialization operation may be performed for the mini-program. In the context of the present disclosure, the operation instruction may represent various user interactions made by the user, for example, click, double click, and slide. For example, the initialization operation may be performed upon detecting that the user clicks on an icon of the mini-program. The initialization operation may include basic functions for configuring the mini-program, for example, including but not limited to at least one of the following: a tenant configuration operation, a user configuration operation, a multilingual configuration operation, a function activation configuration operation, a checkpoint configuration operation, and an error reporting configuration operation.

In particular, the tenant configuration operation refers to configuring tenant information associated with the mini-program. For example, if the mini-program is a management application program for a store, the information of the store needs to be verified. The user configuration operation refers to verifying information of a user who logs in to the mini-program, for example, a login name and a password. The multilingual configuration operation refers to setting a language environment of the mini-program based on a language environment of a client device running the mini-program. The function activation configuration operation refers to setting an activated function for the mini-program based on factors such as user classification. The checkpoint configuration operation refers to specifying data expected to be collected during the running of the mini-program. The error reporting configuration operation refers to setting a way of reporting an error in an abnormal situation, and so on.

It should be understood that the above initialization operation is merely an example, and more and/or fewer operations may be performed according to the respective function of the mini-program and the specific application environment of the native application. With the example implementation of the present disclosure, a unified initialization operation may be provided for different application scenes supported by the mini-program, thereby facilitating the mini-program to focus on providing respective specific functions in different application scenes.

According to an example implementation of the present disclosure, each initialization operation may be performed in a parallel, thereby improving the initialization efficiency and reducing the waiting time for loading the mini-program. It should be understood that the function of the pedestal 310 depends on the completion of the initialization. Before the initialization is completed, the state of the pedestal 310 may be set to “not ready”, and after the initialization process, the state of the pedestal 310 may be updated to “ready”. At this time, the pedestal 310 may be called to perform a subsequent function.

According to an example implementation of the present disclosure, the pedestal 310 may recognize the plurality of application scenes supported by the mini-program from the scene configuration 260. FIG. 4 illustrates a block diagram 400 of a structure of a scene configuration according to some implementations of the present disclosure. As shown in FIG. 4, the scene configuration 260 may include the plurality of application scenes supported by the mini-program 210. For example, a scene identifier 410 (for example, SceneType) may uniquely indicate an identifier of an upper application scene. Alternatively and/or additionally, the scene identifier 410 may further specify an association relationship between the application scene and the data table. For example, the scene identifier 410 may include a data table identifier 420 (that is, a token of an online spreadsheet for storing related data of the scene identifier 410). For an application scene 340 for performing patrol management, related data may be stored in a data table, table1, for example.

According to an example implementation of the present disclosure, the scene configuration may further specify a plurality of page styles for presenting the plurality of data tables respectively. That is, the scene identifier 410 may further indicate a page style for presenting a data table associated with the scene identifier 410. Specifically, a page style identifier 422 may be used to identify a corresponding page style. In this way, an association relationship may be conveniently established among each application scene, a related data table of each application scene, and a page style for presenting the related data table.

It should be understood that FIG. 4 is merely schematic, and alternatively and/or additionally, the scene configuration 260 may include more scene identifiers. For example, the scene configuration 260 may further include: a scene identifier for indicating an application scene 350 of employee management, and a scene identifier for indicating an application scene 360 of inventory management, and so on. In this way, the scene configuration 260 may conveniently and accurately represent an association relationship among the application scene, the data table, and the corresponding page style, thereby facilitating presenting data in each data table in the data source in a corresponding manner.

According to an example implementation of the present disclosure, the data source may be generated by another mini-program “online spreadsheet” provided by the native program. For example, the user may use the “online spreadsheet” function to create a data source. The user may specify a structure of a data table in the data source. For example, a name and/or an identifier of the data table may be specified, names of fields in the data table may be specified, and formats of the fields may be specified, for example, a number type, a text type, a Boolean format, an image type, and so on. A data record may be added to the data table, contents of the data record may be modified, and/or an added data record may be deleted.

For example, the data table, table1, for supporting the “patrol management” application scene may include a plurality of fields: time, patrol content, status, remarks, and patrol photos, and so on, to record related data during each store patrol. For another example, the data table, table2, for supporting the “employee management” application scene may include a plurality of fields: employee number, employee name, gender, entry time, photo, and position. For yet another example, the data table, table3, for supporting the “inventory management” application scene may include a plurality of fields: product number, product name, product price, product description, product photo, and remaining inventory.

Further, a user of the data source, that is, a user who uses the “online spreadsheet” mini-program to create and/or manage the data source, may create the scene configuration 260 in the format described above. For example, it may be specified that: a scene identifier of the “patrol management” application scene is scenetype1, a data table identifier is table1, and a page style identifier is pagestyle1. Similarly, it may be specified that: a scene identifier of the “employee management” application scene is scenetype2, a data table identifier is table2, and a page style identifier is pagestyle2. For another example, it may be specified that: a scene identifier of the “inventory management” application scene is scenetype3, a data table identifier is table3, a page style identifier is pagestyle3, and so on.

With the example implementation of the present disclosure, an association relationship may be conveniently established among each application scene of the mini-program, the data table, and the page display format. At this time, a user without programming experience can also create a mini-program with basic data management capabilities by setting the scene configuration 260.

According to an example implementation of the present disclosure, the pedestal 310 may identify each application scene supported by the mini-program, and the corresponding data table and page style from the scene configuration 260. The pedestal 310 may load data in each data table to facilitate presenting each data table based on a corresponding page style.

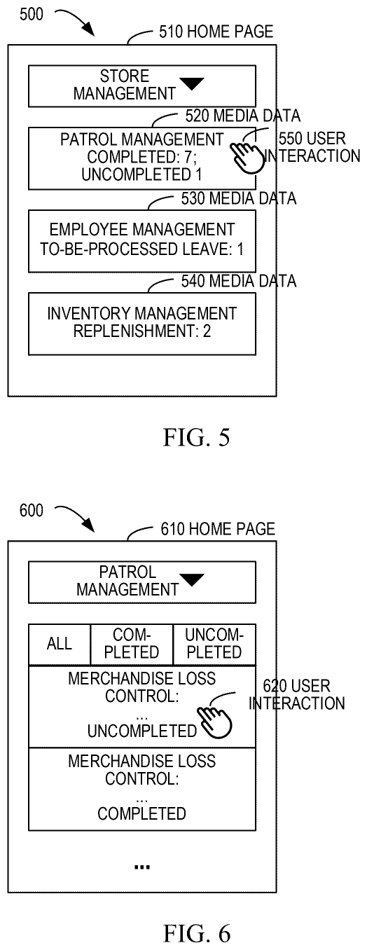

With reference to FIG. 5, more information about presenting data is described. FIG. 5 illustrates a block diagram 500 of a home page of a mini-program according to some implementations of the present disclosure. As shown in FIG. 5, a plurality of media data corresponding to a plurality of data tables may be presented on a home page 510. For example, a plurality of switching controls for switching to the plurality of application scenes may be presented. For example, a “down arrow” in FIG. 5 may be clicked. A switching box 224 shown in FIG. 2 may be presented after clicking the “down arrow”, and the user may be informed to select a desired application scene from the switching box 224. Alternatively and/or additionally, an application scene list may be opened by clicking on the “down arrow”, and then a desired application scene may be selected from the list.

According to an example implementation of the present disclosure, the plurality of media data may include summary data and/or statistical data of each application scene, and so on. For example, media data 520 may represent the completion status of related tasks in the “patrol management” application scene; media data 530 may represent the completion status of related tasks in the “employee management” application scene; media data 540 may represent the completion status of related tasks in the “inventory management” application scene, and so on.

According to an example implementation of the present disclosure, the user may interact with the switching control to switch to a desired application scene. For example, the user may click a switching control corresponding to a target application scene, and then switch to a corresponding target application scene. Specifically, if a user interaction for the target switching control in the plurality of switching controls, which is for switching to a target application scene corresponding to a target switching control, is detected, a target data table corresponding to the target application scene may be presented in the mini-program.

In the example shown in FIG. 5, the user may select which application scene is expected to be entered in a pop-up switching box and/or a drop-down list. Alternatively and/or additionally, the user may also enter a corresponding application scene by clicking on the media data. For example, if a user interaction 550 between the user and the media data 520 is received, the “patrol management” application scene may be entered. Subsequently, more information about the “patrol management” application scene may be presented in a subsequent page.

According to an example implementation of the present disclosure, in the process of presenting the target data table, the target data table may be presented in accordance with a target page style corresponding to the target data table in the plurality of page styles. Here, the target page style may specify at least one page format for presenting the target data table. The page styles of each application scene may have the same or different formats. In most cases, the user expects to view summary information, list information, and detailed information of the data table. At this time, corresponding page formats may be constructed respectively to present various information in accordance with the predetermined format. In this way, common requirements of most users may be extracted, and corresponding page formats may be set.

According to an example implementation of the present disclosure, a data item in the target data table may include at least one of the following: text data, image data, video data, and link data. In this case, presenting the target data table in accordance with the target page style may comprise: presenting the data item in accordance with the target page style. For example, the page style may specify a position for presenting each data item; the page style may further specify a font for presenting the text data, a resolution for presenting the image data, and so on. In this way, various contents in the target data table are presented as specified by the user.

Alternatively and/or additionally, each data table may have a respective permission management setting, and the user is allowed to access the corresponding data table only if the user has a specified permission. Further, how to present each data item in the data table may be defined in a predetermined order. For example, data in the data table may be presented in the order of an initial page, a list page, a detailed page, and a forwarding page.

According to an example implementation of the present disclosure, the page format may include an initial page format for presenting summary information of at least one data record in the target data table. Here, the initial page format may specify content presented in an initial page, and see FIG. 6 for more details. FIG. 6 illustrates a block diagram 600 of an initial page of a mini-program according to some implementations of the present disclosure. FIG. 6 shows an initial page 610 in the “patrol management” application scene. For example, the initial page format may specify which fields of data in the data table are presented in the initial page. In the process of presenting the target data table in accordance with the target page style, an initial page of the target data table may be generated based on the initial page format, and then summary information of at least one data record in the target data table is presented in the initial page.

According to an example implementation of the present disclosure, assuming that the data table includes a plurality of fields: time, patrol content, status, remarks, patrol photos, and so on, the initial page format may specify to present one or more of the above fields. For example, it may be specified to present the patrol content and the status, then the initial page 610 may present summary information of a first data record: (1) a patrol content field: “merchandise loss control . . . ”; and (2) a status field: “uncompleted”. Further, the initial page 610 may present summary information of a second data record: (1) a patrol content field: “merchandise loss control . . . ”; and (2) a status field: “completed”, and so on. In this way, the user may be facilitated to specify information expected to be viewed in the initial page, thereby facilitating the user to understand desired content without having to turn to other pages.

According to an example implementation of the present disclosure, the initial page format may specify a filtering condition expected to be executed. In other words, only data records that satisfy the filtering condition may be presented in the initial page. As shown in FIG. 6, the initial page 610 may include filtering conditions represented by pagination tabs: all, completed, or uncompleted. Each pagination tab may be clicked respectively to view data records that satisfy a certain filtering condition. For example, the “uncompleted” pagination tab may be clicked to view data records with a status of “uncompleted”. In this way, the filtering condition may be customized by modifying the initial page format without the code of the mini-program, thereby presenting data records that satisfy the expected condition in the initial page 610.

According to an example implementation of the present disclosure, the page format may further include a list page format for presenting a data record in the at least one data record. The list page format may specify detailed information of each field in the data table for presentation. For example, detailed information of all fields and/or at least some fields may be presented. Specifically, the user may perform a user interaction 620 (for example, clicking on the data record) with a certain data record in the initial page 610. At this time, the data record may be referred to as a target data record. If a user interaction for a target data record in the at least one data record in the initial page 610 is received, the target data record may be presented based on the list page format. Specifically, a list page of the target data record may be generated based on the list page format, and then list information of the target data record is presented in the generated list page.

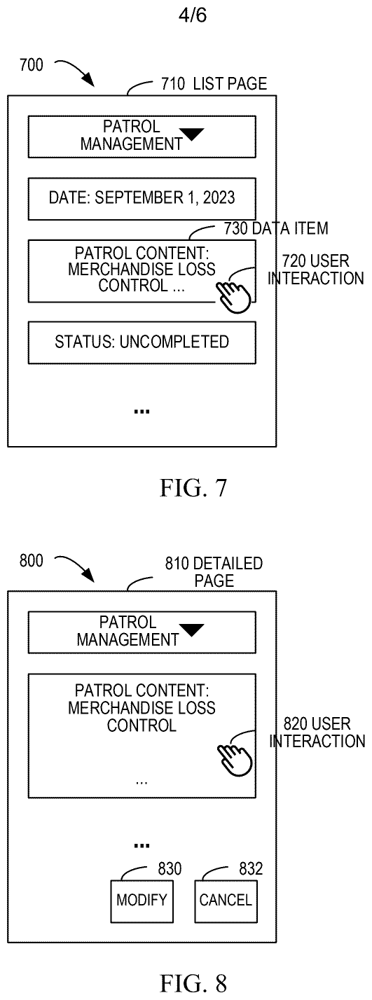

With reference to FIG. 7, more details about the list page are described. FIG. 7 illustrates a block diagram 700 of a list page of a mini-program according to some implementations of the present disclosure. In a case where the list page format specifies to present all fields in the data table, the list page may present all the following fields: time, patrol content, status, remarks, and patrol photos. As shown in FIG. 7, the user may slide on the list page 710 to present information of more fields.

According to an example implementation of the present disclosure, the page format may further include a detailed page format for presenting detailed information of a data item in the list page. It should be understood that the detailed page format may specify to present more information of the data item, for example, a type of the data item (for example, a number type, a text type, an image type, and so on), a specific content of the data item, a modification time of the data item, a modifier of the data item, an operation that may be performed on the data item, and so on. At this time, the user may select a data item expected to be further viewed and/or modified through a user interaction 720 such as clicking. For example, the user may click on a data item 730 in the list page 710 to present more information of the data item 730 in a subsequent page.

According to an example implementation of the present disclosure, if a user interaction for a target data item in the list page is received, a detailed page of the target data item may be generated based on the detailed page format. Further, detailed information of the target data item may be presented in a detailed page 810 of the target data item. See FIG. 8 for more information, wherein FIG. 8 illustrates a block diagram 800 of a detailed page of a mini-program according to some implementations of the present disclosure. Assuming that the detailed page format specifies to present a specific content of the data item and a modification operation may be performed on the data item, a detailed page 810 as shown in FIG. 8 may be generated at this time.

As shown in FIG. 8, the user may press a modify 830 button to modify the specific content in the data item. According to an example implementation of the present disclosure, upon receiving a user interaction 820 for the detailed page, the target data item in the data table may be updated. For example, the user may perform an add, delete, and/or modify operation based on the original content to generate an updated data item. According to an example implementation of the present disclosure, the updated data item may be saved in the data table for access by other users. With the example implementation of the present disclosure, it is possible to specify which content in the data table is allowed to be modified by the user by modifying the detailed page format without having to modify the code of the mini-program. In this way, the program development efficiency can be improved.

According to an example implementation of the present disclosure, upon detecting a user interaction for refreshing the mini-program, the data source may be reloaded. For example, the user who has performed the above modification operation may refresh his/her mini-program, and at this time, the reloaded updated data source will be presented in the mini-program. Alternatively and/or additionally, other users may also refresh their respective mini-programs, and the updated data source will be presented at this time. With the example implementation of the present disclosure, it is not necessary to exit and reload the mini-program, but the data in the data source may be shared among multiple users in a more efficient manner.

It should be understood that the above only describes specific details of the initial page format, the list page format, and the detailed page format by way of example. Alternatively and/or additionally, the page style may include more or fewer page formats. For example, on the basis of the three more general page formats described above, more page formats may be specified in the page style. For example, for the “patrol management” application scene, a forwarding page format may be set. The forwarding page format may define a forwarding page for forwarding a data record in the at least one data record.

According to an example implementation of the present disclosure, upon receiving a user interaction for a target data record in the at least one data record, a forwarding page of the target data record may be generated based on the forwarding page format. For example, in the “patrol management” application scene, assuming that the user (for example, a manager) finds that there may be a problem with a certain data record, the data record may be forwarded to another user (for example, a store clerk) at this time.

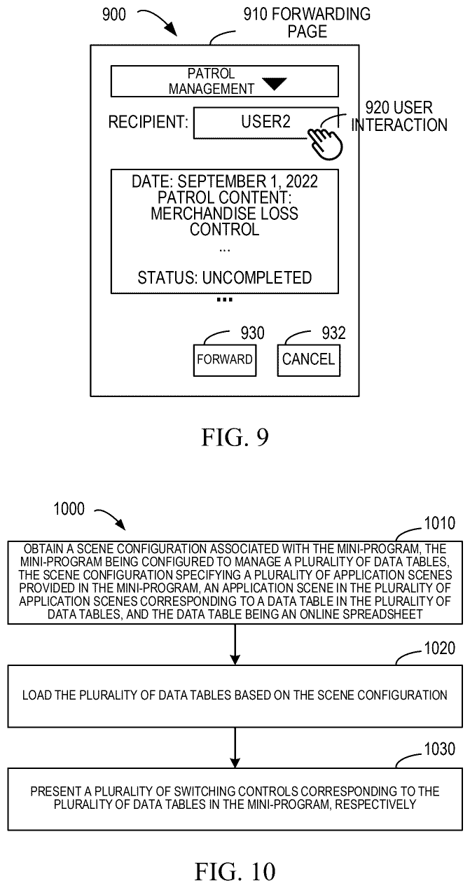

FIG. 9 illustrates a block diagram 900 of a forwarding page of a mini-program according to some implementations of the present disclosure. As shown in FIG. 9, a forwarding page 910 may be generated based on the forwarding page format. The forwarding page 910 may include a recipient. For example, the user may specify a desired recipient through a user interaction 920. It should be understood that the recipient may be selected from an address book in the native program, for example. Alternatively and/or additionally, for example, an email address, a mobile phone number, etc. may be entered to receive the forwarded data record. When the recipient has been entered, if a user interaction for specifying a recipient of the target data record is received (for example, the user presses a forward 930 button), the target data record may be forwarded to the recipient. The user may press a cancel 932 button to cancel the forwarding operation.

It should be understood that the forwarding page format described above is merely schematic, and the user may set more or fewer pages in the page style according to his/her own needs. For example, in the application scene of “inventory management”, an order page may be further provided, so that the user may contact a supplier through the order page when finding a shortage of inventory of goods, thereby completing an order operation.

It should be understood that each page shown in FIG. 5 to FIG. 9 above is merely schematic, and other pages including different content may be generated based on specific requirements of different application scenes. With the example implementation of the present disclosure, the mini-program may be directly generated based on the scene configuration, and the function of the mini-program is adjusted by only modifying the scene configuration. In this way, the development process of the mini-program can be greatly simplified, thereby supporting ordinary users to quickly develop and/or adjust the mini-program for accessing and managing the data source without programming knowledge.

### Example Process

FIG. 10 illustrates a flowchart of a method 1000 for managing a mini-program based on a scene configuration according to some implementations of the present disclosure, where the mini-program is used to manage a data source including a plurality of data tables. At block 1010, a scene configuration associated with a mini-program is obtained, wherein the mini-program is used to manage the plurality of data tables, the scene configuration specifies a plurality of application scenes provided in the mini-program, an application scene in the plurality of application scenes corresponds to a data table in the plurality of data tables, and the data table is an online spreadsheet. At block 1020, the plurality of data tables is loaded based on the scene configuration. At block 1030, a plurality of switching controls corresponding to the plurality of data tables are separately presented in the mini-program.

According to an example implementation of the present disclosure, the method further comprises: in response to detecting an operation instruction for a target switching control in the plurality of switching controls, presenting a target data table corresponding to the target switching control in the mini-program.

According to an example implementation of the present disclosure, the scene configuration includes a page style for presenting the data table respectively, and presenting the target data table further comprises: presenting the target data table in accordance with a target page style corresponding to the target data table, the target page style specifying at least one page format for presenting the target data table.

According to an example implementation of the present disclosure, the at least one page format includes an initial page format for presenting at least one data record in the target data table, and presenting the target data table in accordance with the target page style comprises: generating an initial page of the target data table based on the initial page format; and presenting, in the initial page, the at least one data record in the target data table.

According to an example implementation of the present disclosure, the at least one page format further includes a list page format for presenting a target data record in the at least one data record, and the method further comprises: in response to receiving an operation instruction for a target data record in the at least one data record in the initial page, generating a list page of the target data record based on the list page format; and presenting list information of the target data record in the list page.

According to an example implementation of the present disclosure, the at least one page format further includes a detailed page format for presenting detailed information of a data item in the list page, and the method further comprises: in response to receiving an operation instruction for a target data item in the list page, generating a detailed page of the target data item based on the detailed page format; and presenting detailed information of the target data item in a detailed page of the target data item.

According to an example implementation of the present disclosure, the method further comprises: in response to receiving an operation instruction for the detailed page, updating the target data item in the data table.

According to an example implementation of the present disclosure, the method further comprises: in response to detecting an operation instruction for refreshing the mini-program, reloading the data source; and presenting the reloaded data source in the mini-program.

According to an example implementation of the present disclosure, the at least one page format further includes a forwarding page format for forwarding a data record in the at least one data record, and the method further comprises: in response to receiving an operation instruction for a target data record in the at least one data record, generating a forwarding page of the target data record based on the forwarding page format; and in response to receiving an operation instruction in the forwarding page for specifying a recipient of the target data record, forwarding the target data record to the recipient.

According to an example implementation of the present disclosure, a data item in the target data table includes at least one of the following: text data, image data, video data, and link data, and presenting the target data table in accordance with the target page style comprises: presenting the data item in accordance with the target page style.

According to an example implementation of the present disclosure, obtaining the scene configuration comprises: in response to receiving an operation instruction for starting the mini-program, performing an initialization operation for the mini-program; and in response to the initialization operation being completed, obtaining the scene configuration.

According to an example implementation of the present disclosure, the initialization operation includes at least one of the following: a tenant configuration operation, a user configuration operation, a multilingual configuration operation, a function activation configuration operation, a checkpoint configuration operation, and an error reporting configuration operation.

According to an example implementation of the present disclosure, the mini-program and the data source are provided by a native program, and the scene configuration is set by a user of data source.

### Example Apparatus and Device

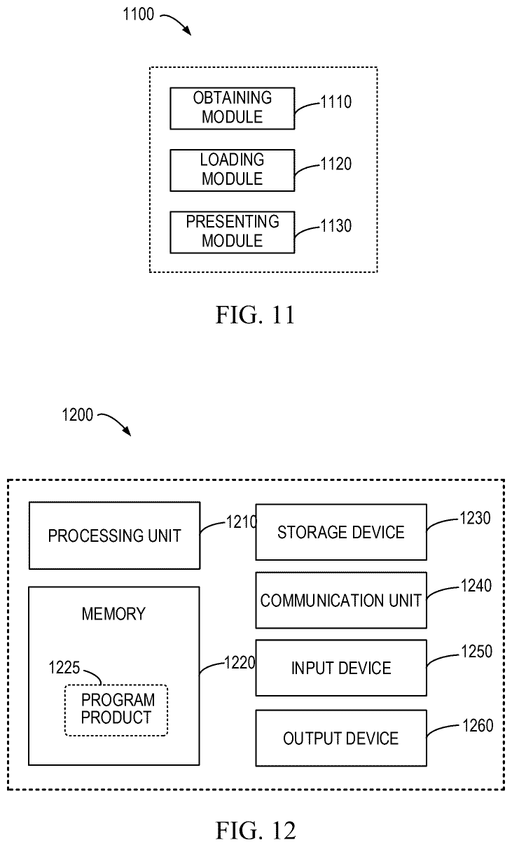

FIG. 11 illustrates a block diagram of an apparatus 1100 for managing a mini-program based on a scene configuration according to some implementations of the present disclosure. The apparatus includes: an obtaining module 1110, configured to obtain a scene configuration associated with a mini-program, the mini-program being used to manage a plurality of data tables, the scene configuration specifying a plurality of application scenes provided in the mini-program, an application scene in the plurality of application scenes corresponding to a data table in the plurality of data tables, and the data table being an online spreadsheet; a loading module 1120, configured to load the plurality of data tables based on the scene configuration; and a presenting module 1130, configured to present a plurality of switching controls corresponding to the plurality of data tables in the mini-program, respectively.

According to an example implementation of the present disclosure, the apparatus further comprises: a data table presenting module configured to, in response to detecting an operation instruction for a target switching control in the plurality of switching controls, present a target data table corresponding to the target switching control in the mini-program.

According to an example implementation of the present disclosure, the scene configuration includes a page style for presenting the data table, and the data table presenting module further includes: a style-based presentation module, configured to present the target data table in accordance with a target page style corresponding to the target data table, the target page style specifying at least one page format for presenting the target data table.

According to an example implementation of the present disclosure, the at least one page format includes an initial page format for presenting at least one data record in the target data table, and the style-based presentation module includes: an initial page generation module, configured to generate an initial page of the target data table based on the initial page format; and an initial page presentation module, configured to present the at least one data record in the target data table in the initial page.

According to an example implementation of the present disclosure, the at least one page format further includes a list page format for presenting a target data record in the at least one data record, and the apparatus further comprises: a list page generation module configured to, in response to receiving an operation instruction for a target data record in the at least one data record in the initial page, generate a list page of the target data record based on the list page format; and a list page presentation module, configured to present list information of the target data record in the list page.

According to an example implementation of the present disclosure, the at least one page format further includes a detailed page format for presenting detailed information of a data item in the list page, and the apparatus further comprises: a detailed page generation module configured to, in response to receiving an operation instruction for a target data item in the list page, generate a detailed page of the target data item based on the detailed page format; and a detailed page presentation module, configured to present detailed information of the target data item in a detailed page of the target data item.

According to an example implementation of the present disclosure, the apparatus further comprises: an update module, configured to update the target data item in the data table in response to receiving an operation instruction for the detailed page.

According to an example implementation of the present disclosure, the apparatus further comprises: a reloading module, configured to reload the data source in response to detecting an operation instruction for refreshing the mini-program; and the presentation module is further configured to present the reloaded data source in the mini-program.

According to an example implementation of the present disclosure, the at least one page format further includes a forwarding page format for forwarding a data record in the at least one data record, and the apparatus further comprises: a forwarding page generation module configured to, in response to receiving an operation instruction for a target data record in the at least one data record, generate a forwarding page of the target data record based on the forwarding page format; and a forwarding page presentation module configured to, in response to receiving an operation instruction in the forwarding page for specifying a recipient of the target data record, forward the target data record to a recipient.

According to an example implementation of the present disclosure, a data item in the target data table includes at least one of the following: text data, image data, video data, and link data, and the style-based presentation module is further configured to: present the data item in accordance with the target page style.

According to an example implementation of the present disclosure, the obtaining module includes: an initialization module configured to, in response to receiving an operation instruction for starting the mini-program, perform an initialization operation for the mini-program; and a configuration obtaining module configured to, in response to the initialization operation being completed, obtain the scene configuration.

According to an example implementation of the present disclosure, the initialization operation includes at least one of the following: a tenant configuration operation, a user configuration operation, a multilingual configuration operation, a function activation configuration operation, a checkpoint configuration operation, and an error reporting configuration operation.

According to an example implementation of the present disclosure, the mini-program and the data source are provided by a native program, and the scene configuration is set by a user of the data source.

FIG. 12 illustrates a block diagram of a device 1200 capable of implementing multiple implementations of the present disclosure. It should be understood that the computing device 1200 shown in FIG. 12 is merely example and should not constitute any limitation to the functions and scope of the implementations described herein. The computing device 1200 shown in FIG. 12 may be used to implement the method described above.

As shown in FIG. 12, the computing device 1200 is in the form of a general-purpose computing device. Components of the computing device 1200 may include, but are not limited to, one or more processors or processing units 1210, a memory 1220, a storage device 1230, one or more communication units 1240, one or more input devices 1250, and one or more output devices 1260. The processing unit 1210 may be a physical or virtual processor and may perform various processes according to programs stored in the memory 1220. In a multi-processor system, a plurality of processing units executes computer-executable instructions in parallel to improve the parallel processing capability of the computing device 1200.

The computing device 1200 usually includes a plurality of computer storage media. Such media may be any available media accessible by the computing device 1200, including but not limited to volatile and non-volatile media, detachable and non-detachable media. The memory 1220 may be a volatile memory (for example, a register, cache, Random Access Memory (RAM)), a non-volatile memory (for example, Read-Only Memory (ROM), Electrically Erasable Programmable Read-Only Memory (EEPROM), flash memory), or some combination thereof. The storage device 1230 may be a detachable or non-detachable medium, and may include a machine-readable medium, such as a flash drive, a disk, or any other medium that may be used to store information and/or data (for example, training data for training) and may be accessed within the computing device 1200.

The computing device 1200 may further include additional detachable/non-detachable, volatile/non-volatile storage media. Although not shown in FIG. 12, a disk drive for reading from or writing to a detachable, non-volatile disk (for example, a “floppy disk”) and an optical disk drive for reading from or writing to a detachable, non-volatile optical disk may be provided. In these cases, each drive may be connected to a bus (not shown) through one or more data medium interfaces. The memory 1220 may include a computer program product 1225 having one or more program modules configured to perform various methods or actions of various implementations of the present disclosure.

The communication unit 1240 communicates with other computing devices through a communication medium. Additionally, the functions of the components of the computing device 1200 may be implemented by a single computing cluster or multiple computing machines, which can communicate through a communication connection. Therefore, the computing device 1200 may operate in a networked environment using a logical connection with one or more other servers, network personal computers (PCs), or another network node.

The input device 1250 may be one or more input devices, such as a mouse, keyboard, tracking ball, and so on. The output device 1260 may be one or more output devices, such as a display, speaker, printer, and so on. The computing device 1200 may further communicate with one or more external devices (not shown) through the communication unit 1240 as needed, such as a storage device, a display device, and so on, to communicate with one or more devices that enable a user to interact with the computing device 1200, or to communicate with any device (for example, a network card, a modem, and so on) that enables the computing device 1200 to communicate with one or more other computing devices. Such communication may be performed via an input/output (I/O) interface (not shown).

According to an example implementation of the present disclosure, there is provided a computer-readable storage medium having computer-executable instructions stored thereon, wherein the computer-executable instructions are executed by a processor to implement the method described above. According to an example implementation of the present disclosure, there is also provided a computer program product, which is tangibly stored on a non-transitory computer-readable medium and includes computer-executable instructions, and the computer-executable instructions are executed by a processor to implement the method described above. According to an example implementation of the present disclosure, there is provided a computer program product having a computer program stored thereon, and when the program is executed by a processor, the method described above is implemented.

Various aspects of the present disclosure are described here with reference to flowcharts and/or block diagrams of methods, apparatuses, devices, and computer program products implemented according to the present disclosure. It should be understood that each block of the flowcharts and/or block diagrams, and combinations of blocks in the flowcharts and/or block diagrams may be implemented by computer-readable program instructions.

These computer-readable program instructions may be provided to a processing unit of a general-purpose computer, a special-purpose computer, or another programmable data processing apparatus to produce a machine, such that these instructions, when executed by a processing unit of a computer or another programmable data processing apparatus, generate a device for implementing the functions/actions specified in one or more blocks in the flowcharts and/or block diagrams. These computer-readable program instructions may also be stored in a computer-readable storage medium, and these instructions cause a computer, a programmable data processing apparatus, and/or another device to work in a specific manner, so that the computer-readable medium storing the instructions includes a product that includes instructions for implementing various aspects of the functions/actions specified in one or more blocks in the flowcharts and/or block diagrams.

The computer-readable program instructions may be loaded onto a computer, another programmable data processing apparatus, or another device, so that a series of operation steps are performed on the computer, another programmable data processing apparatus, or another device to produce a computer-implemented process, such that the instructions executed on the computer, another programmable data processing apparatus, or another device implement the functions/actions specified in one or more blocks in the flowcharts and/or block diagrams.

The flowcharts and block diagrams in the accompanying drawings show the possibly implemented architecture, functions, and operations of the system, method, and computer program product according to multiple implementations of the present disclosure. In this regard, each block in the flowchart or block diagram may represent a module, program segment, or part of an instruction, and the module, program segment, or part of an instruction contains one or more executable instructions for implementing the specified logical functions. In some alternative implementations, the functions marked in the blocks may also occur in an order different from that marked in the accompanying drawings. For example, two consecutive blocks may actually be performed substantially in parallel, or they may sometimes be performed in the reverse order, depending on the function involved. It should also be noted that each block in the block diagram and/or flowchart, and a combination of blocks in the block diagram and/or flowchart may be implemented by a dedicated hardware-based system that executes specified functions or actions, or may be implemented by a combination of dedicated hardware and computer instructions.

The various implementations of the present disclosure have been described above. The above description is example, not exhaustive, and is not limited to the disclosed implementations. Many modifications and changes are obvious to those of ordinary skill in the art without departing from the scope and spirit of the described implementations. The selection of terms used herein is intended to best explain the principles, practical applications, or improvements to the technology in the market of the implementations, or to enable other ordinary skilled persons in the art to understand the various implementations disclosed herein.

1. A method for processing a mini-program, comprising:
obtaining a scene configuration associated with the mini-program, the mini-program being configured to manage a plurality of data tables, the scene configuration specifying a plurality of application scenes provided in the mini-program, an application scene in the plurality of application scenes corresponding to a data table in the plurality of data tables, and the data table being an online spreadsheet;
loading the plurality of data tables based on the scene configuration; and
presenting a plurality of switching controls corresponding to the plurality of data tables in the mini-program, respectively.

2. The method of claim 1, further comprising: in response to detecting an operation instruction for a target switching control in the plurality of switching controls, presenting a target data table corresponding to the target switching control in the mini-program.

3. The method of claim 2, wherein the scene configuration comprises page styles for presenting the data tables respectively, and presenting the target data table further comprises: presenting the target data table in accordance with a target page style corresponding to the target data table, the target page style specifying at least one page format for presenting the target data table.

4. The method of claim 3, wherein the at least one page format comprises an initial page format for presenting at least one data record in the target data table, and presenting the target data table in accordance with the target page style comprises:
generating an initial page of the target data table based on the initial page format; and
presenting, in the initial page, the at least one data record in the target data table.

5. The method of claim 4, wherein the at least one page format further comprises a list page format for presenting a target data record in the at least one data record, the method further comprising:
in response to receiving an operation instruction for the target data record in the at least one data record in the initial page, generating a list page of the target data record based on the list page format; and
presenting list information of the target data record in the list page.

6. The method of claim 5, wherein the at least one page format further comprises a detailed page format for presenting detailed information of a data item in the list page, the method further comprising:
in response to receiving an operation instruction for a target data item in the list page, generating a detailed page of the target data item based on the detailed page format; and
presenting the detailed information of the target data item in the detailed page of the target data item.

7. The method of claim 6, further comprising: in response to receiving an operation instruction for the detailed page, updating the target data item in the data table.

8. The method of claim 1, further comprising:
in response to detecting an operation instruction for refreshing the mini-program, reloading data source; and
presenting the reloaded data source in the mini-program.

9. The method of claim 4, wherein the at least one page format further comprises a forwarding page format for forwarding a data record in the at least one data record, the method further comprising:
in response to receiving an operation instruction for a target data record in the at least one data record, generating a forwarding page of the target data record based on the forwarding page format; and
in response to receiving an operation instruction in the forwarding page for specifying a recipient of the target data record, forwarding the target data record to the recipient.

10. The method of claim 3, wherein a data item in the target data table comprises at least one of: text data, image data, video data, link data, and presenting the target data table in accordance with the target page style comprises: presenting the data item in accordance with the target page style.

11. The method of claim 1, wherein obtaining the scene configuration comprises:
in response to receiving an operation instruction for starting the mini-program, performing an initialization operation for the mini-program; and
in response to the initialization operation being completed, obtaining the scene configuration.

12. The method of claim 1, wherein the initialization operation comprises at least one of: a tenant configuration operation, a user configuration operation, a multilingual configuration operation, a function activation configuration operation, a checkpoint configuration operation, and an error reporting configuration operation.

13. The method of claim 1, wherein the mini-program and a data source are provided by a native program, and the scene configuration is set by a user of data source.

14. An electronic device, comprising:
at least one processing unit; and
at least one memory coupled to the at least one processing unit and storing instructions executable by the at least one processing unit, the instructions, when executed by the at least one processing unit, causing the electronic device to perform acts comprising:
obtaining a scene configuration associated with the mini-program, the mini-program being configured to manage a plurality of data tables, the scene configuration specifying a plurality of application scenes provided in the mini-program, an application scene in the plurality of application scenes corresponding to a data table in the plurality of data tables, and the data table being an online spreadsheet;
loading the plurality of data tables based on the scene configuration; and
presenting a plurality of switching controls corresponding to the plurality of data tables in the mini-program, respectively.

15. The electronic device of claim 14, the acts further comprise: in response to detecting an operation instruction for a target switching control in the plurality of switching controls, presenting a target data table corresponding to the target switching control in the mini-program.

16. The electronic device of claim 15, wherein the scene configuration comprises page styles for presenting the data tables respectively, and presenting the target data table further comprises: presenting the target data table in accordance with a target page style corresponding to the target data table, the target page style specifying at least one page format for presenting the target data table.

17. The electronic device of claim 16, wherein the at least one page format comprises an initial page format for presenting at least one data record in the target data table, and presenting the target data table in accordance with the target page style comprises:
generating an initial page of the target data table based on the initial page format; and
presenting, in the initial page, the at least one data record in the target data table.

18. The electronic device of claim 17, wherein the at least one page format further comprises a list page format for presenting a target data record in the at least one data record, the acts further comprise:
in response to receiving an operation instruction for the target data record in the at least one data record in the initial page, generating a list page of the target data record based on the list page format; and
presenting list information of the target data record in the list page.

19. The electronic device of claim 18, wherein the at least one page format further comprises a detailed page format for presenting detailed information of a data item in the list page, the acts further comprise:
in response to receiving an operation instruction for a target data item in the list page, generating a detailed page of the target data item based on the detailed page format; and
presenting the detailed information of the target data item in the detailed page of the target data item.

20. A non-transitory computer-readable storage medium having a computer program stored thereon, the computer program, when executed by a processor, causing the processor to implement a method comprising:
obtaining a scene configuration associated with the mini-program, the mini-program being configured to manage a plurality of data tables, the scene configuration specifying a plurality of application scenes provided in the mini-program, an application scene in the plurality of application scenes corresponding to a data table in the plurality of data tables, and the data table being an online spreadsheet;
loading the plurality of data tables based on the scene configuration; and
presenting a plurality of switching controls corresponding to the plurality of data tables in the mini-program, respectively.
